(19) United States
(12) Patent Application Publication
(10) Pub. No.: US 2022/0248175 A1
(43) Pub. Date: Aug. 4, 2022

(54) METHOD FOR GENERATING AN AWARENESS MESSAGE FROM A FIRST ROAD USER, AND METHOD AND DEVICE FOR ASSISTING A SECOND ROAD USER

(71) Applicant: Orange, Issy-les-Moulineaux (FR)

(72) Inventors: Cédric Seureau, Chatillon Cedex (FR); Dominique Jezequel, Chatillon Cedex (FR)

(21) Appl. No.: 17/612,795

(22) PCT Filed: May 14, 2020
(86) PCT No.: PCT/EP2020/063432

§ 371 Date: Nov. 19, 2021

(30) Foreign Application Priority Data
May 27, 2019 (FR) 1905568

(51) Int. Cl. H04W 4/024; H04W 4/14; H04W 4/40; H04W 4/029; G01C 21/36

(52) U.S. Cl. CPC H04W 4/024; H04W 4/14; G01C 21/3626; H04W 4/029; H04W 4/40

(57) ABSTRACT

Protection of vulnerable road users. The vulnerable road users are in particular pedestrians and users of non-motor vehicles such as bicycles, scooters etc. as well as light electric vehicles. A method for generating knowledge messages from a first road user to be sent to at least one device for assisting a second road user, includes: integrating into the knowledge message at least one calculated datum regarding the status of the first road user. Thus, in addition to the current position of the first road user measured by the smartphone (GPS measurement), the knowledge message includes other items of status data which are based on a calculation. This provides more detailed knowledge regarding the behaviour of the first road user and thus reduces the risk of collisions with a second road user.

### CROSS-REFERENCE TO RELATED APPLICATIONS

This Application is a Section 371 National Stage Application of International Application No. PCT/EP2020/063432, filed May 14, 2020, the content of which is incorporated herein by reference in its entirety, and published as WO 2020/239455 on Dec. 3, 2020, not in English.

### TECHNICAL FIELD

The invention relates to the protection of vulnerable road users as they do not have external status indicators such as brake lights, turn-signal lights, in particular direction indicators, etc. Said vulnerable road users are in particular users of non-motor vehicles: pedestrians, roller skates, skateboards, bicycles, scooters, etc., as well as light electric vehicles such as electrically assisted bicycles, electric scooters, etc., more generally called “pedestrians” or “very light vehicles”.

The invention proposes a method for generating awareness messages from a first road user, a method for protecting a first road user, a method for assisting a second road user capable of receiving awareness messages from a first road user, a communication device of a first road user, an assistance device of a second road user and a communication device of a second road user.

### PRIOR ART

According to statistics, more than 3000 people die every day because of dangerous driving and one quarter of these people are road users referred to as vulnerable. The main reason for the accidents is the inability of road users to detect and recognize future hazards before the time that is necessary for their reaction to be able to avoid the accidents: one in two takes place at night!

In order to reduce accidents with pedestrians, a large amount of attention has been given to detecting pedestrians and predicting a possibility of collision by using detectors and vision processing techniques. However, such detector-based techniques exhibit limited performance if visibility conditions are poor (night, bad weather, etc.) or if the pedestrian is not close enough (less than 10 meters) or not in the line of sight (NLOS for “non-line-of-sight”).

It is therefore necessary to study and develop different techniques to reduce these accidents further. One of these techniques is to use communication technology to provide an extended view of road users in conditions in which the vulnerable road user is not in the line of sight.

Even if making driving safer is one of the important topics of research in the field of telecommunication, most of the work is centered on avoiding collisions between motor vehicles, more generally called vehicles, in particular automobiles, buses, coaches, trams, trucks, etc., by focusing on V2V communications, that is to say vehicle-to-vehicle communications, and V2I communications, that is to say vehicle-to-infrastructure communications, such as traffic lights, speed limit signs, tolls, etc.

However, the 3GPP consortium is proposing a “Cellular V2X” standard that also describes V2P communications, that is to say vehicle-to-pedestrian communications. These communications allow vehicles (motor vehicles) to be informed of the presence of pedestrians and/or allow pedestrians (more generally users of light vehicles), by means of their smartphone, to be informed of the existence of arriving vehicles.

In particular, the ETSI EN 302637-2 standard defines cooperative awareness messages, CAM, allowing every road user to remain aware of others. The message in particular comprises status information including in particular the date, the position, the movement status, the activated systems of the vehicles, etc. For a motor vehicle, the cooperative awareness message includes the dated GPS position (recovered from the navigation device); the movement status in particular comprises the speed (provided by the speedometer) as well as the direction (provided by the GPS and/or the turn-signal indicator), the activated systems (in particular the brakes).

While the preparation of cooperative awareness messages for motor vehicles allows fine awareness for vehicles, this is not the case for pedestrians. In general, the only information transmitted is the position provided by the pedestrian's smartphone. Vulnerable road users therefore continue to be not very visible to motor vehicles. Anticipating their actions in order to adapt the driving of a motor vehicle is difficult or even impossible in braking or turning information.

Without this information, the risks of accident are real for light vehicles (bicycles, scooters, light electric vehicles, etc.) among themselves as well as with any other vehicles and pedestrians. Moreover, this lack of information can lead to dangerous actions (overtaking, turning, etc.) from a vehicle driven by a human being or from an autonomous vehicle (in particular driven by artificial intelligence) on account of poor assessment of the behavior of a “pedestrian” in its immediate surroundings (the former immediately, for example).

### SUMMARY OF THE INVENTION

One of the aims of the present invention is to make improvements over the prior art.

One subject of the invention is a method for generating awareness messages from a first road user for at least one assistance device of a second road user, the generation method comprising integration of at least one computed datum regarding the status of the first road user into said awareness message. Thus, apart from the current position of the first road user as measured by a smartphone or another onboard communication device (GPS measurement), the awareness message includes other status data such as braking, turning, current route, etc., which are established following a computation. This allows finer awareness of the behavior of the first road user and thus reduces the risks of collision with a second road user. The generation of awareness messages from a first road user allows knowledge relating to this first road user to be provided to second road users.

Advantageously, the method for generating awareness messages comprises a computation of at least one datum regarding the status of the first road user.

Thus, this reduces times for taking account of the knowledge included in the message and therefore increases the probability of avoiding a collision because there is no transmission time for the results of a remote computation, in particular in another device, from a communication network (cloud) to the device of the first road user implementing awareness message generation.

Advantageously, the computed datum regarding the status of the first road user results from a computation of at least one of the following types:
a computation on the basis of at least one measured datum regarding the current status of the first road user,

Thus, the computed status datum takes account of the current status of the first user: geographical position, as well as position on the road (upright, lying down), movement (constant speed, rapid deceleration, rapid acceleration, etc.) or command performed explicitly by the user. For example, the accelerometer of the smartphone or of a connected object (watch) worn by the first road user assesses the first user to be lying on the ground. The computed status datum will therefore be “accident”.
a navigation computation allowing information relating to a route to be reproduced for the first road user,

Thus, the navigation information is not only provided to the first road user requesting a route but is also used by second road users present around this first road user to take account of its route in their driving. Either the message directly comprises the computed route provided to the first user or the message comprises more precise status data such as the position computed for an instant T taking account not only of the V2P transmission time but also of the reaction time to avoid a collision, any turning (on the basis of the computed route), etc.
a prediction computation for predicting a route on the basis of data regarding the current status of the first road user.

Thus, a predicted route of a first road user is used not only by the communication terminal of the first road user to provide information about shops (adverts, actions to be taken: shopping), vehicles (protection), friends, etc., that are present on its route but also by second road users present around this first road user to take account of its route in their driving. Either the message directly comprises the route predicted to the first user or the message comprises more precise status data such as the position predicted for an instant T taking account not only of the V2P transmission time but also of the reaction time to avoid a collision, any turning (on the basis of the predicted route), etc.

Another subject of the invention is a method for protecting a first road user, comprising
generation of an awareness message from a first road user for at least one assistance device of a second road user, integrating at least one computed datum regarding the status of the first road user into said awareness message, and
transmission of the generated awareness message for the at least one assistance device of a second road user.

Advantageously, the transmission is a transmission of at least one of the following types:
a direct transmission for the assistance devices of the second road user that are situated in the transmission cell of the first road user,

Thus, as the transmission time is reduced, the time for the second road user to react is longer, allowing the risks of collision to be reduced.
a transmission via a mobile communication network.

Thus, the transmission is safer and the messages are processed by more powerful computers (speed of computations, load, etc.); the resultant data are more precise and more reliable.

One subject of the invention is also a method for assisting a second road user capable of receiving awareness messages from a first road user, the assistance method comprising processing of awareness messages received from a first road user on the basis of at least one datum regarding the status of the second road user.

Advantageously, the processing comprises modification of a driving assistance datum on the basis of the awareness message received and at least one datum regarding the status of the second road user.

Advantageously, the assistance method comprises announcement of a warning awareness message for the second road user if the result of the processing identifies a risk.

Advantageously, the processing comprises a computation of an updated route on the basis of the awareness message received and at least one datum regarding the status of the second road user.

Advantageously, the processing comprises a computation of a command from the second road user on the basis of the awareness message received and at least one datum regarding the status of the second road user.

Advantageously, according to one implementation of the invention, the various steps of the method according to the invention are implemented by software or a computer program, this software comprising software instructions intended to be executed by a data processor of a device that forms part of a communication device and being designed to control the execution of the various steps of this method.

The invention is therefore also aimed at a program comprising program code instructions for executing the steps of the method for generating awareness messages and/or a method for protecting a first road user and/or the assistance method when said program is executed by a processor.

This program can use any programming language and be in the form of source code, object code or intermediate code between source code and object code, such as in a partially compiled form or in any other desirable form.

One subject of the invention is also a communication device of a first road user, comprising:
a transmitter allowing communication with at least one communication device of a second road user and
a generator of awareness messages from a first road user for at least one assistance device of a second road user, the generator integrating at least one computed datum regarding the status of the first road user into said awareness message.

One subject of the invention is moreover a driving assistance device of a second road user capable of receiving awareness messages from a first road user, the assistance device comprising a processor for processing the awareness messages received from a first road user on the basis of at least one datum regarding the status of the second road user.

Advantageously, the driving assistance device is implemented in a device from among the following:
a driving aid device,
a navigation device,
a control device of the vehicle,
an autonomous driving device.

One subject of the invention is additionally a communication device of a second road user, comprising:
a receiver allowing communication with at least one communication device of a first road user and
an assistant capable of receiving awareness messages from a first road user, the assistant processing the awareness messages received from a first road user on the basis of at least one datum regarding the status of the second road user.

### BRIEF DESCRIPTION OF THE DRAWINGS

The features and advantages of the invention will emerge more clearly on reading the description, provided by way of example, and the figures relating thereto, in which:

FIG. 1 shows a simplified diagram of a method for generating awareness messages from a first road user according to the invention,

FIG. 2 shows a simplified diagram of assistance of a second road user according to the invention,

FIG. 3 shows a simplified diagram of a communication architecture comprising a first and a second road user, according to the invention,

FIG. 4a shows a simplified diagram of a first instance of use of the invention in which an awareness message for a turn indication from the first road user is transmitted to second road users,

FIG. 4b FIG. 4b shows a simplified diagram of a second instance of use of the invention in which an awareness message for a turn indication from the first road user is transmitted to one second road user,

FIG. 5 shows a simplified diagram of a third instance of use of the invention in which an awareness message for a braking indication from the first road user is transmitted to the second road users,

FIG. 6 shows a simplified diagram of a fourth instance of use of the invention in which an awareness message for a breakdown or accident indication from the first road user is transmitted to the second road users.

### DESCRIPTION OF THE EMBODIMENTS

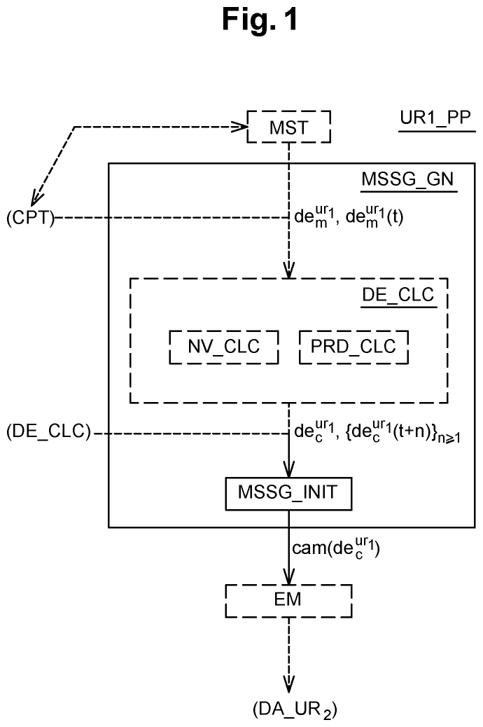

FIG. 1 illustrates a simplified diagram of a method for generating awareness messages from a first road user according to the invention.

The method for generating awareness messages MSS_GN from a first road user UR₁ for at least one assistance device DA_UR₂ of a second road user comprises integration MSSG_INT of at least one computed datum regarding the status of the first road user de_{c}^{ur1} into said awareness message cam.

In particular, the method for generating awareness messages MSSG_GN comprises a computation of at least one datum regarding the status of the first road user DE_CLC. Alternatively, the computation of at least one datum regarding the status of the first road user DE_CLC is performed by a third-party method, optionally at the request of the method for generating awareness messages MSSG_GN optionally comprising a measured datum regarding the current status of the first road user deₘ^{ur1}, deₘ^{ur1} (t), prior to the integration MSSG_INT.

In particular, the computed datum regarding the status of the first road user de_{c}^{ur1} results from a computation of at least one of the following types:
a computation on the basis of at least one measured datum regarding the current status of the first road user deₘ^{ur1}, deₘ^{ur1} (t),
a navigation computation NV_CLC allowing information relating to a route to be reproduced for the first road user,
a prediction computation PRD_CLC for predicting a route on the basis of data regarding the current status of the first road user.

The computed status datum de_{c}^{ur1} is in particular a status from among the following: normal, stopped, moving, braking, turning right, turning left, broken down, accident, etc., respectively computed on the basis of a measured current-status datum such as speed of movement, data measured by accelerometers allowing identification of a sharp deceleration, turning, connected sensors of a bicycle (for example on the bicycle's derailleur), a change of position of the first road user and/or of its operator (vertical or horizontal position), etc.

The prediction computation PRD_CLC for prediction on the basis of current-status data allows prediction of a route of the first road user and/or of actions of the first road user such as braking, turning, etc. In particular, the prediction computation PRD_CLC is moreover dependent on a status data history.

In particular, the generation of awareness messages MSSG_GN is performed on the basis of status data measured either by sensors CPT or during a measurement MST performed prior to the message generation MSSG_GN.

A method for protecting a first road user UR1_PP comprises
generation of an awareness message MSSG_GN from a first road user for at least one assistance device of a second road user, integrating at least one computed datum regarding the status of the first road user into said awareness message, and
transmission EM of the generated awareness message to the at least one assistance device of a second road user.

In particular, the transmission EM is a transmission of at least one of the following types:
a direct transmission for the assistance devices DA_UR₂ of the second road user that are situated in the transmission cell of the first road user,
a transmission via a mobile communication network.

In particular, an embodiment of the method for generating awareness messages MSSG_GN and/or of the method for protecting the first road user UR1_PP is a program comprising program code instructions for executing the steps of the method for generating awareness messages from the first road user and/or of the method for protecting a first road user when said program is executed by a processor.

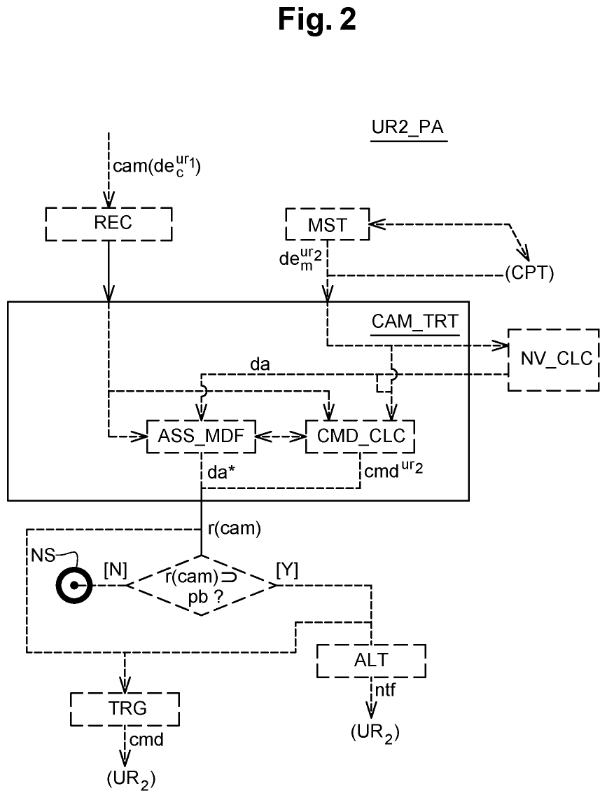

FIG. 2 illustrates a simplified diagram of assistance of a second road user according to the invention.

The method for assisting a second road user UR2_PA is capable of receiving awareness messages from a first road user cam(de_{c}^{ur1}). The assistance method UR2_PA comprises processing CAM_TRT of awareness messages received from a first road user on the basis of at least one datum regarding the status of the second road user deₘ^{ur2}.

In particular, the processing of awareness messages CAM_TRT is performed on the basis of status data measured either by sensors CPT or during a measurement MST performed prior to the message processing CAM_TRT.

In particular, the processing CAM_TRT comprises modification ASS_MDF of a driving assistance datum da on the basis of the awareness message received cam and at least one datum regarding the status of the second road user deₘ^{ur2}. The modification ASS_MDF thus provides a modified assistance datum da* (for example, an indication of action and/or a route to be followed).

In particular, the assistance method UR2_PA comprises announcement ntf of a warning awareness message for the second road user UR₂ if the result of the processing identifies a risk r(cam)⊃pb=[N].

In particular, the processing CAM_TRT comprises a computation of an updated route on the basis of the awareness message received cam and at least one datum regarding the status of the second road user deₘ^{ur2}.

In particular, the processing CAM_TRT comprises a computation of a command CMD_CLC from the second road user on the basis of the awareness message received and at least one datum regarding the status of the second road user. The command computation CMD_CLC provides a command from at least one piece of equipment of the second road user (brake, steering wheel, accelerator, etc.) cmd^{ur2}.

In particular, one embodiment of the assistance method is a program comprising program code instructions for executing the steps of the assistance method when said program is executed by a processor.

In particular, the assistance method UR2_PA comprises reception REC of an awareness message from a first road user cam(de_{c}^{ur1}) prior to the message processing CAM_TRT.

In particular, the message processing CAM_TRT receives driving assistance data da obtained from a navigation computation NV_CLC. Particularly, the assistance method UR2_PA comprises the navigation computation NV_CLC. Optionally, the navigation computation NV_CLC is performed at the request of the message processing CAM_TRT.

In particular, following the processing of the message CAM_TRT, the assistance method UR2_PA comprises a triggering TRG of a command cmd from a piece of equipment of the second road user UR2.

In particular, the assistance method UR2_PA comprises a check on whether the result of the processing identifies a risk r(cam)⊃pb?. If so [Y], the assistance method optionally comprises a warning ALT notifying ntf the operator of the second road user UR2 and/or a triggering TRG of a command cmd from a piece of equipment of the second road user UR2.

In particular, if not [N], the assistance method UR2_PA performs no additional step NS.

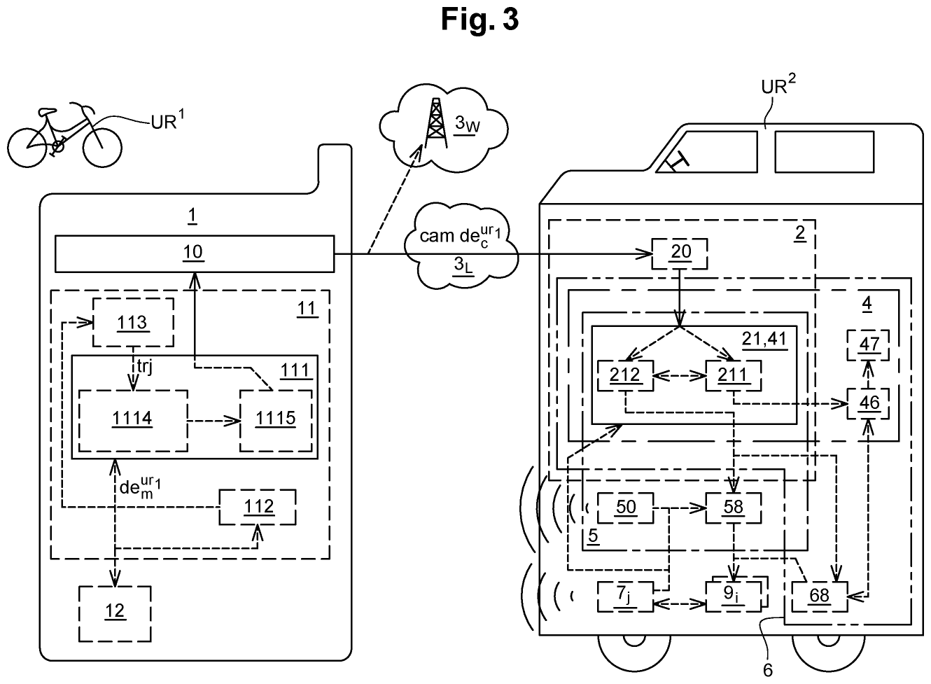

FIG. 3 illustrates a simplified diagram of a communication architecture comprising a first UR¹ and a second UR² road user, according to the invention.

The communication device 1 of a first road user UR¹ comprises:
a transmitter 10 allowing communication with at least one communication device 2 of a second road user UR² and
a generator 111 of awareness messages from a first road user for at least one device 21 for assisting a second road user, the generator 111 integrating at least one computed datum regarding the status of the first road user into said awareness message.

In particular, the generator 111 of awareness messages from a first road user UR₁ for at least one assistance device DA_UR₂ of a second road user comprises an integrator 1115 of at least one computed datum regarding the status of the first road user de_{c}^{ur1} into said awareness message cam.

In particular, the awareness message generator 111 comprises a computer for computing at least one datum regarding the status of the first road user 1114.

In particular, the computed datum regarding the status of the first road user de_{c}^{ur1} is provided by one of the following computers:
a navigation computer allowing information relating to a route to be reproduced for the first road user,
a prediction computer for predicting a route on the basis of data regarding the current status of the first road user. Particularly, the prediction computer moreover performs computations on the basis of a status data history.

In particular, the awareness message generator 111 uses status data measured either by sensors 12 or by a measuring device 12.

In particular, the communication device 1 of the first road user UR1 comprises a protection device 11 for protecting the first road user. The protection device 11 comprises
the generator 111 of awareness messages from the first road user for at least one assistance device of a second road user, integrating at least one computed datum regarding the status of the first road user into said awareness message, and
a transmitter 10 of the awareness message generated for the at least one device 21, 41 for assisting a second road user.

In particular, the transmitter 10 is a transmitter of at least one of the following types:
a direct transmitter for the assistance devices 21, 41 of the second road user UR₂ that are situated in the transmission cell of the first road user UR1,
a transmitter via a mobile communication network (3G, 4G, 5G, etc.).

The driving assistance device 21, 41 of a second road user is capable of receiving awareness messages from a first road user. The assistance device 21, 41 comprises a processor for processing the awareness messages received from a first road user on the basis of at least one datum regarding the status of the second road user.

In particular, the driving assistance device is implemented in a device from among the following:
a driving aid device 4,
a navigation device 4,
a control device of the vehicle 5,
an autonomous driving device 6.

In particular, the control device of the vehicle 5 comprises sensors 50 and a generator for controlling at least one piece of equipment 9i of the second road user UR2.

In particular, the autonomous driving device 6 receives modified assistance data da* and/or commands cmd. Particularly, the autonomous driving device 6 comprises an adapter 68 capable of taking account of modified assistance data and/or commands provided by the assistance device 21, 41 in the driving command generation.

The communication device 2 of a second road user UR² comprises:
a receiver 20 allowing communication with at least one communication device 1 of a first road user UR¹ and
an assistant 21, 41 capable of receiving awareness messages from a first road user, the assistant 21, 41 processing the awareness messages received from a first road user on the basis of at least one datum regarding the status of the second road user.

The assistance device of a second road user 21, 41 is capable of receiving awareness messages from a first road user cam(de_{c}^{ur1}). The assistance device 21, 41 comprises a processor for processing awareness messages received from a first road user on the basis of at least one datum regarding the status of the second road user deₘ^{ur2}.

In particular, the processor for processing awareness messages performs the processing on the basis of status data measured either by sensors 7j or by a measuring device 7j.

In particular, the processing processor comprises a modifier 211 for modifying a driving assistance datum da on the basis of the awareness message received cam and at least one datum regarding the status of the second road user deₘ^{ur2}. The modifier 211 thus provides a modified assistance datum da* (for example, an indication of action and/or a route to be followed).

In particular, the assistance device 21, 41 comprises an announcement generator ntf for announcing a warning awareness message for the second road user UR2, generating an announcement if the result provided by the message processing processor identifies a risk r(cam)⊃pb=[N].

In particular, the processing processor comprises a computer for computing an updated route on the basis of the awareness message received cam and at least one datum regarding the status of the second road user deₘ^{ur2}.

In particular, the processing processor comprises a computer for computing a command 212 from the second road user on the basis of the awareness message received and at least one datum regarding the status of the second road user. The command computer 212 provides a command from at least one piece of equipment of the second road user (brake, steering wheel, accelerator, etc.) cmd^{ur2}.

In particular, the message processing processor receives driving assistance data da obtained from a navigation computer 46. Optionally, a reproduction unit 46 such as a screen and/or loudspeakers reproduce the assistance data da provided by the navigation computer 46. Particularly, the assistance device 21, 41 comprises the navigation computer 46. Optionally, the navigation computer 46 is triggered at the request of the message processing processor.

In particular, following the processing of the message, the assistance device 21, 41 comprises a trigger mechanism for triggering a command cmd from a piece of equipment of the second road user UR2.

In particular, the assistance device 21, 41 comprises a checker for whether the result of the processing identifies a risk r(cam)⊃pb?. If so [Y], the assistance device optionally comprises a warning generator notifying ntf the operator of the second road user UR2 and/or a trigger mechanism for triggering a command cmd from a piece of equipment of the second road user UR2.

In particular, if not [N], the assistance device 21, 41 performs no additional step NS.

In particular, the messages cam are exchanged between the first road user UR1 and the second road user UR2 via a local area communication network 3_{L}, such as a Wifi, Bluetooth, etc., network. Optionally, the awareness messages cam are transmitted to a remote communication network 3_{Wn}, such as the Internet.

Thus, very light vehicles are capable of signaling their presence, their turning, braking or encountering an abnormality without vehicles in the surroundings being clearly informed. The aim of the device is to inform surrounding vehicles (behind, at the sides and in front) of a projected trajectory, of braking or of an abnormality (for example a fall) in order to avoid collisions. Surrounding vehicles may be in direct proximity or behind another vehicle.

The information from “very light” vehicles is communicated to other vehicles by means of a communication device, for example Cellular V2X (LTE-V2X, 5G-V2X, etc.) or any other communication protocol (WiFi, ITS-G5, etc.) in pair-to-pair mode or in series with the network.

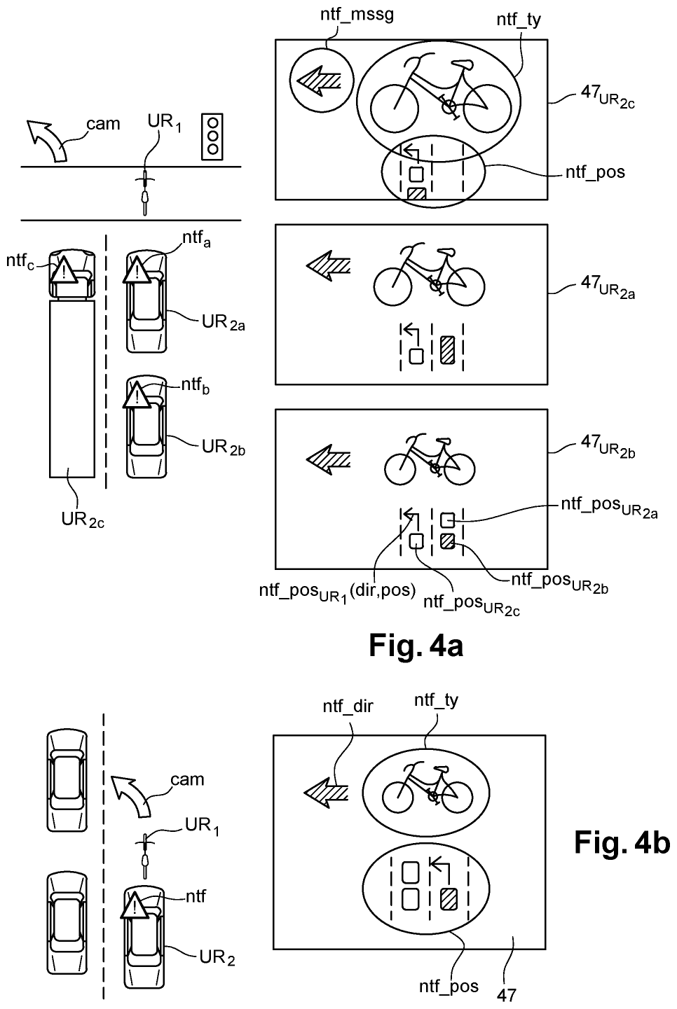

FIGS. 4a and 4b illustrate two instances of use of the invention in which an awareness message for a turn indication from the first road user is transmitted to second road users.

The trajectories of very light vehicles may be known by way of guidance software configured by the user, a prediction of the route of the user (by way of his daily analysis) or through other means such as a turning command.

Surrounding vehicles are alerted to the presence of these very light vehicles and to their change of trajectory in various ways: vehicles driven by a human driver are able to visualize this trajectory by means of any device (visual, audible, etc.). Self-driving vehicles, referred to as autonomous vehicles, can take account of and determine this risk in their driving software. If there are multiple “very light” vehicles on the same level, the device allows their trajectories to be differentiated.

FIG. 4a shows a simplified diagram of a first instance of use of the invention in which an awareness message for a turn indication from the first road user is transmitted to second road users.

In the example in FIG. 4a, motor vehicles are present in two traffic lanes: a truck UR_{2c} in the left-hand lane and two automobiles UR₂ₐ and UR_{2b} in the right-hand lane. In front of the left-hand lane there is a first road user present that is referred to as vulnerable: a bicycle UR₁. The bicycle is going to turn left at the traffic lights. This information is particularly determined either because the user of the bicycle has requested a navigation aid to a destination that has generated a navigation route or because the smartphone of the user of the bicycle comprises a route prediction application. The invention thus allows generation of a left-turn indication message from the first road user, the bicycle UR1. This message is sent and then announced ntfa, ntfb, ntfc to the second road users UR2a, UR2b, UR2c.

In particular, the right-hand side of FIG. 4a shows the driving assistance screen of each of the second road users 47_{UR2c}, 47_{UR2a}, 47_{UR2b}. The screen particularly shows the message ntf_mssg, in this case the left turn by the first road user UR1. Optionally, it also indicates the type of road user ntf_ty, in this case a bicycle. Particularly, it may also indicate the position ntf_pos of the first road user UR1 relative to the second road users UR2a, UR2b, UR2c. In this case, the first road user is symbolized by its turn, the second road user receiving the message and displaying the message is symbolized by the filled square and the other second road users are symbolized by empty squares.

In this first instance of use, all of the second road users involved in the lanes in the same direction of travel are recipients of the awareness message from the first road user.

FIG. 4b shows a simplified diagram of a second instance of use of the invention in which an awareness message for a turn indication from the first road user is transmitted to one second road user.

In the example in FIG. 4b, motor vehicles are present in two traffic lanes: two automobiles in the left-hand lane and one automobile UR₂ in the right-hand lane. In front of the right-hand lane there is a first road user present that is referred to as vulnerable: a bicycle UR₁. The bicycle is going to turn left at the traffic lights. A message is sent and then announced ntf to the second road user UR2.

In particular, the right-hand side of FIG. 4b shows the driving assistance screen of the second road user 47. The screen particularly shows the message, in this case the left turn ntf_dir by the first road user UR1. Optionally, it also indicates the type of road user ntf_ty, in this case a bicycle. Particularly, it may also indicate the position ntf_pos of the first road user UR1 relative to the other road users. In this case, the first road user is symbolized by its turn, the second road user receiving the message and displaying the message is symbolized by the filled square and the other road users are symbolized by empty squares.

In this second instance of use, only the second road users sharing the same traffic lane are recipients of the awareness message from the first road user.

FIG. 5 illustrates a simplified diagram of a third instance of use of the invention in which an awareness message for a braking indication from the first road user is transmitted to the second road users.

When very light vehicles brake, vehicles behind comprehend the braking situation after an analysis time and vehicles that are not able to see the very light vehicles directly do not comprehend the situation as a whole and are unable to analyze the reason for the vehicle directly in front of them braking, which can cause inadequate behavior.

Surrounding vehicles are alerted to the presence of these very light vehicles and to their braking in various ways: vehicles driven by a human driver are able to visualize this braking by means of any device (visual, audible, etc.). Self-driving vehicles, referred to as autonomous vehicles, can take account of and determine this risk in their driving software.

In the example in FIG. 5, motor vehicles are present in two traffic lanes: two automobiles in the left-hand lane and a bicycle UR_{2c} and two automobiles UR₂ₐ and UR_{2b} in the right-hand lane. In front of the right-hand lane there is a first road user present that is referred to as vulnerable: a bicycle UR₁. The bicycle is braking. This information is particularly determined either by means of sensors (for example accelerometer of the smartphone) or because the user of the bicycle has requested a navigation aid to a destination that has generated a navigation route or because the smartphone of the user of the bicycle comprises a route prediction application. The invention thus allows generation of a braking indication message from the first road user, the bicycle UR1. This message is sent and then announced ntfa, ntfb, ntfc to the second road users UR2a, UR2b, UR2c.

In particular, the right-hand side of FIG. 5 shows the driving assistance screen of each of the second road users 47_{UR2c}, 47_{UR2a}, 47_{UR2b}. The screen particularly shows the message ntf_mssg, in this case the braking of the first road user UR1. Particularly, it may also indicate the position ntf_pos of the first road user UR1 relative to the second road users UR2a, UR2b, UR2c. In this case, the first road user is symbolized by its braking (red light), the second road user receiving the message and displaying the message is symbolized by the filled square and the other second road users are symbolized by empty squares.

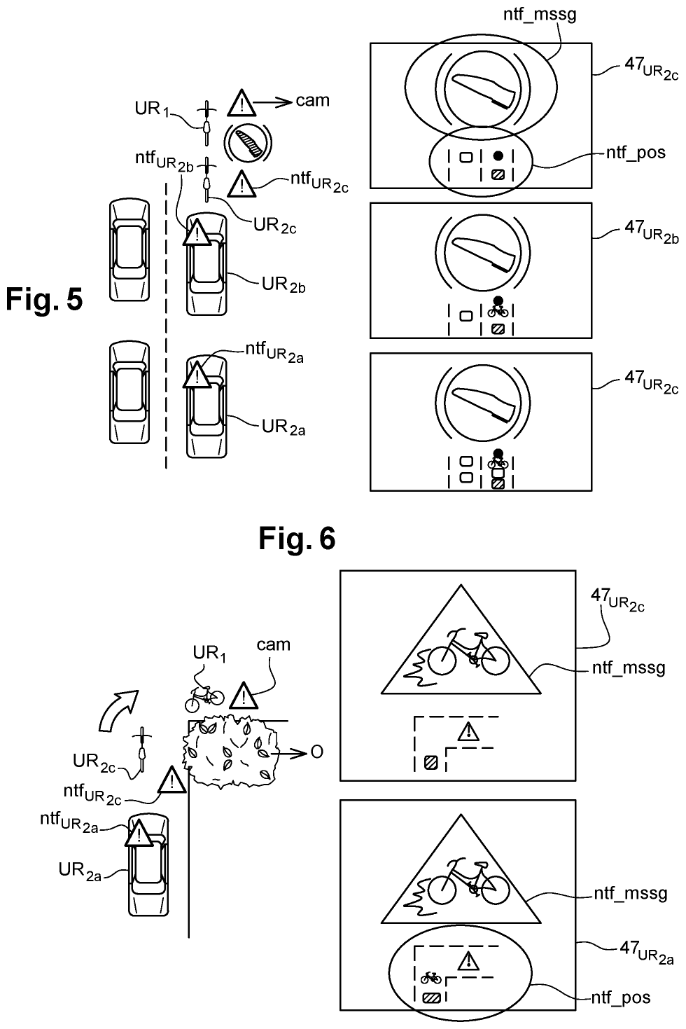

FIG. 6 illustrates a simplified diagram of a fourth instance of use of the invention in which an awareness message for a breakdown or accident indication from the first road user is transmitted to the second road users.

When very light vehicles encounter an abnormality (chain coming off, a fall, etc.), vehicles behind comprehend the abnormal situation after an analysis time and vehicles that are not able to see the very light vehicles directly do not comprehend the situation as a whole and are unable to analyze the behavior of the vehicle directly in front of them, which can cause inadequate behavior.

Surrounding vehicles are alerted to the presence of these very light vehicles and to their abnormality in various ways: vehicles driven by a human driver are able to visualize this braking by means of any device (visual, audible, etc.). Self-driving vehicles, referred to as autonomous vehicles, can take account of and determine this risk in their driving software.

In the example in FIG. 6, a motor vehicle is present in the traffic lane: an automobile UR₂ₐ, and a vulnerable vehicle: a bicycle UR_{2c} before a right-hand bend. After the bend there is a first road user present that is referred to as vulnerable: a bicycle UR₁, which is not visible to the second road users. The bicycle has had a breakdown or an accident. This information is particularly determined either because the user of the bicycle has requested help (call to an emergency number) or because connected equipment of the bicycle particularly allows detection of a chain coming off or because a sensor of the smartphone allows the user to be determined as being in a lying-down position (on the road). The invention thus allows generation of a breakdown or accident indication message from the first road user, the bicycle UR1. This message is sent and then announced ntfa, ntfc to the second road users UR2a, UR2c.

In particular, the right-hand side of FIG. 6 shows the driving assistance screen of each of the second road users 47_{UR2c}, 47_{UR2a}. The screen particularly shows the message ntf_mssg, in the present case the incident (accident, breakdown, etc.) involving the first road user UR1. Particularly, it may also indicate the position ntf_pos of the first road user UR1 relative to the second road users UR2a, UR2b, UR2c. In this case, the first road user is symbolized by an incident indicator, the second road user receiving the message and displaying the message is symbolized by the filled square and the other second road users are symbolized by empty squares.

The invention involves avoiding dangerous situations by way of the communication of information, for example by wrongly anticipating that one or more very light vehicle(s):
will turn left and therefore force the vehicle behind to slow;
will brake and therefore cause potentially emergency braking;
has (have) fallen on the road after a junction and therefore cause dangerous emergency braking.

The invention also concerns a medium. The storage medium may be any entity or device capable of storing the program. For example, the medium may comprise a storage means, such as a ROM, for example a CD ROM or a microelectronic circuit ROM or even a magnetic recording means, for example a floppy disk or a hard disk.

Moreover, the storage medium may be a transmissible medium such as an electrical or optical signal, which may be conveyed via an electrical or optical cable, by radio or by other means. The program according to the invention may in particular be downloaded from a network, particularly of Internet type.

As an alternative, the storage medium may be an integrated circuit in which the program is incorporated, the circuit being designed to execute or to be used in the execution of the method in question.

In another implementation, the invention is performed by means of software and/or hardware components. With this in mind, the term “module” may correspond either to a software component or to a hardware component. A software component corresponds to one or more computer programs, one or more subroutines of a program or, more generally, to any element of a program or of a piece of software that is capable of performing a function or a set of functions according to the description above. A hardware component corresponds to any element of a hardware assembly that is capable of performing a function or a set of functions.

1. A method comprising:
generating, by a communication device of a first road user, awareness messages from the first road user for at least one assistance device of a second road user, the generating comprising integration of at least one computed datum regarding a status of the first road user into said awareness message.

2. The method as claimed in claim 1, wherein the generating awareness messages comprises a computation of at least one datum regarding the status of the first road user.

3. The method as claimed in claim 1, wherein the computed datum regarding the status of the first road user results from a computation of at least one of the following types:
a computation on the basis of at least one measured datum regarding a current status of the first road user,
a navigation computation allowing information relating to a route to be reproduced for the first road user,
a prediction computation for predicting a route on the basis of data regarding the current status of the first road user.

4. The method as claimed in claim 1, comprising:
transmitting the generated awareness message for the at least one assistance device of the second road user.

5. The method as claimed in claim 4, wherein the transmitting comprises at least one of the following types:
a direct transmission for assistance devices of the second road user that are situated in a transmission cell of the first road user,
a transmission via a mobile communication network.

6. A method for assisting a second road user capable of receiving awareness messages from a first road user, the assistance method being implemented by an assistance device of the second road user and comprising:
processing an awareness message received from a communication device of a first road user on the basis of at least one datum regarding a status of the second road user.

7. The method for assisting the second road user as claimed in claim 6, wherein the processing comprises modification of a driving assistance datum on the basis of the awareness message received and at least one datum regarding a status of the second road user.

8. The method for assisting the second road user as claimed in claim 6, wherein the assistance method comprises announcement of a warning awareness message for the second road user if a result of the processing identifies a risk.

9. The method for assisting the second road user as claimed in claim 6, wherein the processing comprises a computation of an updated route on the basis of the awareness message received and at least one datum regarding a status of the second road user.

10. The method for assisting the second road user as claimed in claim 6, wherein the processing comprises a computation of a command from the second road user on the basis of the awareness message received and at least one datum regarding a status of the second road user.

11. A non-transitory computer-readable medium comprising program code instructions stored thereon for executing a method when said program is executed by a processor of a communication device of a first road user, wherein the method comprises:
generating awareness messages from the first road user for at least one assistance device of a second road user, the generating comprising integration of at least one computed datum regarding a status of the first road user into said awareness message.

12. A communication device of a first road user, comprising:
a transmitter allowing communication with at least one communication device of a second road user; and
a generator of awareness messages from the first road user for at least one assistance device of the second road user, the generator integrating at least one computed datum regarding a status of the first road user into said awareness message.

13. A driving assistance device of a second road user capable of receiving awareness messages from a first road user, the assistance device comprising:
a processor configured to process the awareness messages received from a first road user on the basis of at least one datum regarding a status of the second road user.

14. The driving assistance device as claimed in claim 13, wherein the driving assistance device is implemented in a device from among a group consisting of:
a driving aid device,
a navigation device,
a control device of the vehicle,
an autonomous driving device.

15. The driving assistance device of claim 13, comprising:
a receiver allowing communication with at least one communication device of the first road user and to receive the awareness messages from the at least one communication device.
